(19) United States
(12) Patent Application Publication
(10) Pub. No.: US 2007/0084257 A1
(43) Pub. Date: Apr. 19, 2007

(54) Handle blocking system

(76) Inventor: Claudio Papaiz, Sao Paulo (BR)

Correspondence Address: Bliss McGlynn, P.C., Suite 600, 2075 West Big Beaver Road, Troy, MI, 48084, US

(21) Appl. No.: 11/412,636

(22) Filed: Apr. 27, 2006

(30) Foreign Application Priority Data
Oct. 19, 2005 (BR) PI0504792-7

(51) Int. Cl. E05B 59/00; E05B 63/14

(52) U.S. Cl. 70/107

(57) ABSTRACT

The present invention refers to a handle blocking system comprising a lock (1), provided with a handle (2), a latch (3) and a mirror (4).

The lock (1) comprises a blocking device (5), the function of which is to block/unblock the latch (3) and is arranged inside the lock body (1). The device (5) is actuated by an actuation element (6).

### BACKGOUND OF THE INVENTION

1. Field of the Invention

The present invention refers to a handle blocking system, the system being easily actuated by the user by turning a device coupled to the fixed mirror/rosette inside the room.

2. Description of the Related Art

Home security is increasingly sought, as a result of the increasing number of thefts and violence in several cities.

It is worth noting that one concern is that when people are robbed, their belongings may be taken, including, for instance, their bunch keys.

The keys will be under the possession of outlaws that may take the chance and use the keys in the corresponding locks.

Therefore, even inside home, people are subject to an invasion of unauthorized persons.

Additionally, the unauthorized copy of keys is increasingly more common and requires special attention regarding security.

### SUMMARY OF THE INVENTION

The objects of the present invention are reached by providing a handle blocking system comprising a lock, provided with a handle, a latch and a mirror.

The lock comprises a blocking device, the function of which is to block/unblock the latch and is arranged inside the lock body, the device being actuated by an actuation element.

The present invention has several advantages, including:
It prevents unauthorized persons to enter specific locations, even if they have the keys; and
It increases the room security, even if someone having the key loses it.

These and other characteristics, objects and advantages will be evident in the detailed description below about the best mode to carry out the invention when read together with the attached drawings, as well as the claims that are all incorporated as part of the invention disclosure.

### BRIEF DESCRIPTION OF THE DRAWINGS

In the drawings, reference numerals relate to the parts in the several views, wherein:

FIG. 1 is a section view of the system lock object of the present invention;

FIG. 2 is a front view of the system lock object of the present invention, with the actuation element in the free position; and

FIG. 3 is a front view of the system lock object of the present invention, with the actuation element in the blocked position.

### DESCRIPTION OF THE PREFERRED EMBODIMENT(S)

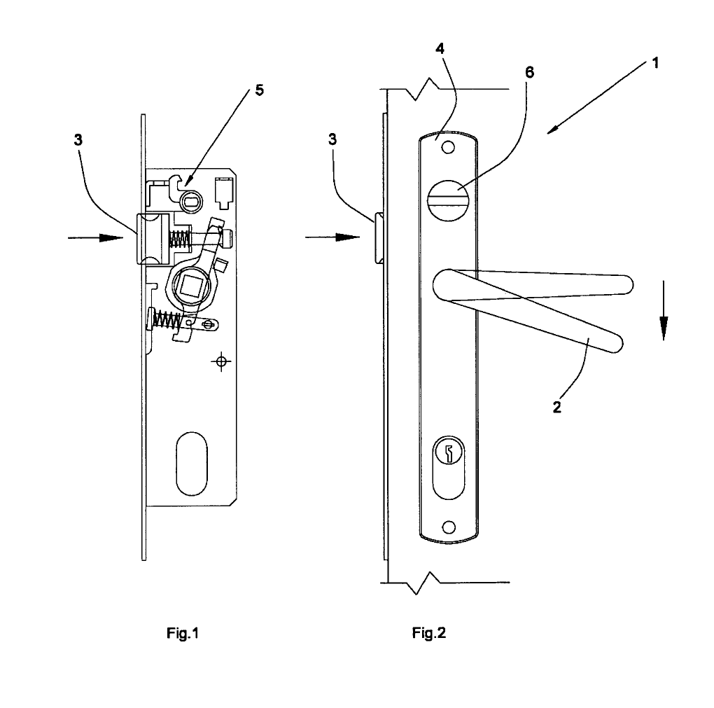

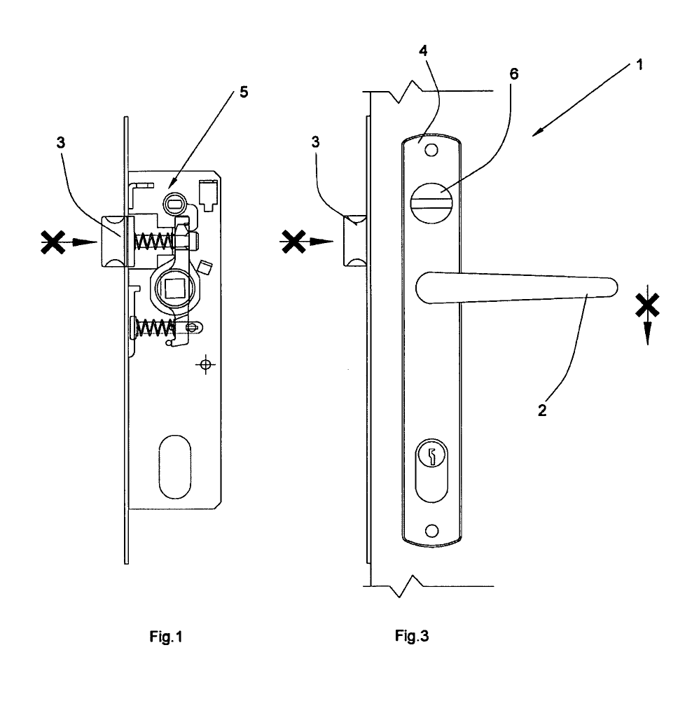

As it may be seen from FIG. 1, the lock 1 comprises a handle 2, a latch 3 and a mirror 4.

The lock 1 further comprises a blocking device 5, the function of which is to block/unblock the latch 3 and is arranged inside the lock body 1. This device 5 is actuated by an actuation element 6 preferably located above the handle 2.

The actuation element 6 is preferably a button, but may assume any shape and is arranged in any position of the mirror 4, provided that this element 6 is inside the room.

The basic security feature of this system is that, when the system is blocked, in this case the handle 2 and the latch 3, an unauthorized person is prevented from entering the room even if he/she has the access key.

Preferably, the actuation element 6 has two positions, that is, free and blocked. When the actuation element 6 is in the free position, the handle is accessible and anyone having the key of lock 1 may enter the room.

When the actuation element 6 is in the blocked position, the handle 2 cannot be moved and latch 3 does not allow lock 1 to be opened, even if the person has the specific key.

The purpose of the invention is to assure security for those persons inside a room when unauthorized persons try to improperly enter said room using an unauthorized key copy/lost keys or even at an unauthorized time.

Evidently, it will be appreciated that although the above was described as an illustrative example of the present invention, all other changes and variations to the invention, as it would be evident for those skilled in the art, are considered within the wide scope of the present invention as per the claims below.

1. “HANDLE BLOCKING SYSTEM” comprising a lock (1), provided with a handle (2), a latch (3) and a mirror (4), characterized in that the lock (1) comprises a blocking device (5), the function of which is to block/unblock the latch (3) and is arranged inside the lock body (1); the device (5) being actuated by an actuation element (6).

2. “HANDLE BLOCKING SYSTEM”, according to claim 1, characterized in that the actuation element (6) is a button.

3. “HANDLE BLOCKING SYSTEM”, according to claim 2, characterized in that the actuation element (6) is arranged in the mirror (4), facing the inside of the room.

4. “HANDLE BLOCKING SYSTEM”, according to claim 3, characterized in that the actuation element (6) has two positions, that is, free and blocked.
